(19) United States
(12) Patent Application Publication
(10) Pub. No.: US 2006/0288807 A1
(43) Pub. Date: Dec. 28, 2006

(54) Engine starter for a radio control model

(76) Inventor: Nai Wen Liu, Taichung City (TW)

Correspondence Address: LIU, NAI WEN, 5F-2, No.212, Sec.1, Wunsin Rd., Taichung City (408), TW

(21) Appl. No.: 11/203,727

(22) Filed: Aug. 16, 2005

(30) Foreign Application Priority Data
Jun. 23, 2005 (TW) 094210618

(51) Int. Cl. F02N 15/06

(52) U.S. Cl. 74/6

(57) ABSTRACT

An engine starter for a radio control model includes an output shaft concentrically connected to and synchronously rotated with a T-shaped drive axle of the engine to start the engine. A drive wheel is sleeved on the output shaft for receiving an extra power. A limit wheel is sleeved on the output and synchronously rotated with the output shaft. The limit wheel is selectively driven by the drive wheel. A gear box is secured on the engine and provided to receive the output shaft, the drive wheel and the limit wheel. A torsion adjust device is mounted to a free end of the output shaft after the output shaft extending through the gear box. The drive wheel is idle running when the torsion force from the engine is greater than that from the torsion adjust device for protecting the engine from a forced operation.

### BACKGROUND OF THE INVENTION

1. Field of the Invention

The present invention relates to an engine starter, and more particularly to an engine starter for a radio control model.

2. Description of Related Art

A conventional engine starter for a radio control model in accordance with the prior art shown in FIG. 7 comprises a body (1) with a chamber (2) defined therein and a piston (3) reciprocally movably received in the chamber (2). A lower end of the piston (3) is connected to a T-shaped drive shaft (5) via a crank (4). The T-shaped drive shaft (5) has a free end longitudinally connected to a start gear box (6). A series of gears are disposed in the start gear box (6) for driving the T-shaped drive shaft (5). An input shaft (6A) rotatably extends from the start gear box (6) for driving the series of gears via an extra power source.

The fuel will be continually pumped for several seconds and slowly enter the carburetor of the engine when starting the engine. Consequently, engine may be locked when the fuel overly enter the carburetor due to a careless operation. Then, the user must immediately stop operating the gear box and detach the spark for draining the overflowed fuel to make the engine be unlocked for next operation.

However, the newcomer usually has not enough experience to make a correct judgement when the engine is locked. As a result, a high torsion is caused sue to a forced operation and the high torsion may break the series of gear in the start gear box.

The present invention has arisen to mitigate and/or obviate the disadvantages of the conventional engine starter for a radio control model.

### SUMMARY OF THE INVENTION

The main objective of the present invention is to provide an improved an engine starter for a radio control model, which protects the engine from a forced operation.

To achieve the objective, the engine starter in accordance with the present invention comprises an output shaft concentrically connected to and synchronously rotated with a T-shaped drive axle of the engine to start the engine. A drive wheel is sleeved on the output shaft for receiving an extra power. A limit wheel is sleeved on the output and synchronously rotated with the output shaft. The limit wheel is selectively driven by the drive wheel. A gear box is secured on the engine and provided to receive the output shaft, the drive wheel and the limit wheel. A torsion adjust device is mounted to a free end of the output shaft after the output shaft extending through the gear box. The drive wheel is idle running when the torsion force from the engine is greater than that from the torsion adjust device for protecting the engine from a forced operation.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of an engine starter for a radio control model in accordance with the present invention;

FIG. 2A is a partial cross-sectional view of the engine of the radio control model;

FIG. 2B is perspective view of the engine starter of the present invention;

FIG. 3 is an exploded perspective view of the engine starter in FIG. 2;

FIG. 4 is a front plan view of the engine starter of the present invention;

FIG. 5 is a cross-sectional view of the engine starter in FIG. 4 along line A-A;

FIG. 6 is a cross-sectional view of the engine starter in FIG. 4 along line B-B; and

FIG. 7 is a side plan view of a conventional engine of a radio control model in partial cross-section in accordance with the prior art.

### DETAILED DESCRIPTION OF THE INVENTION

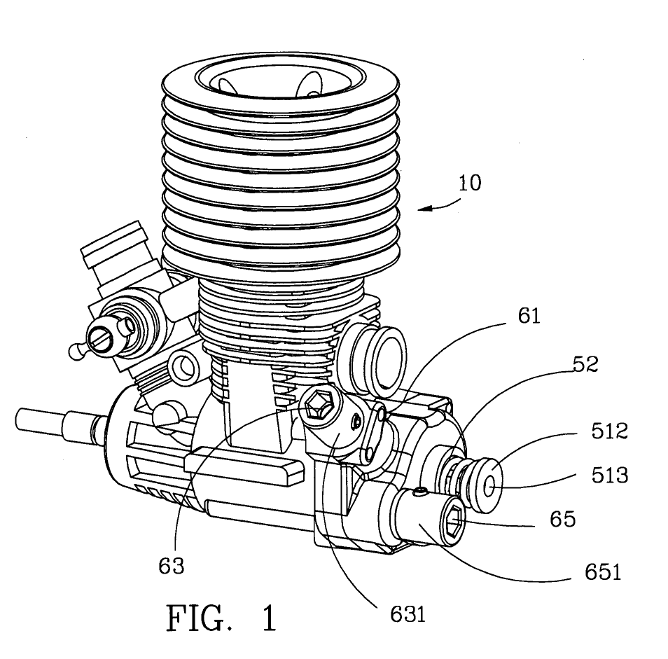

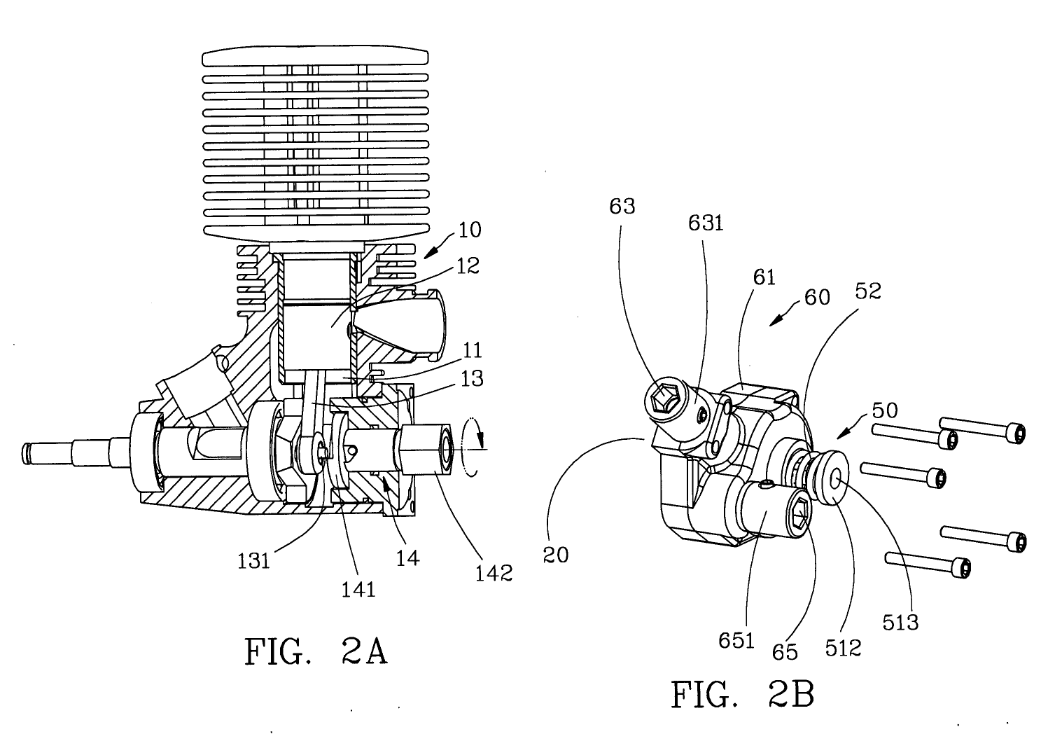

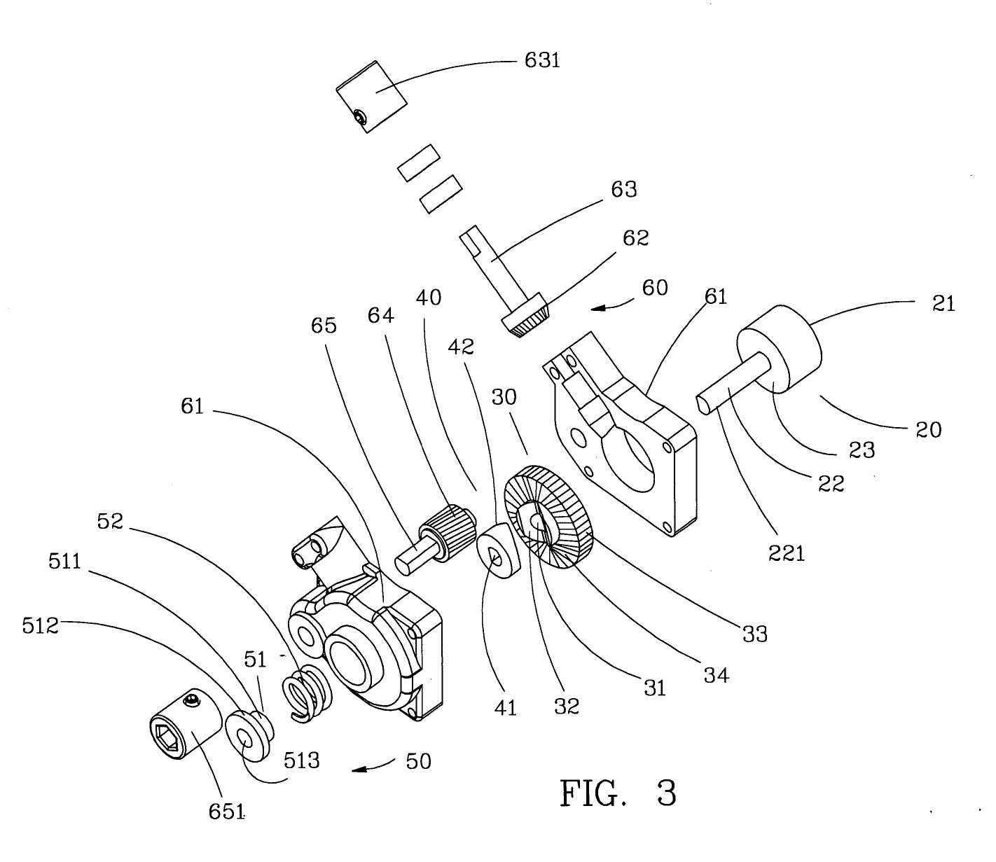

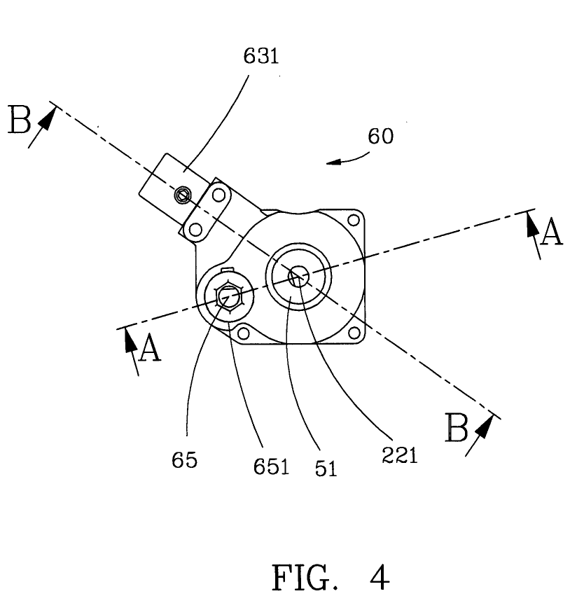

Referring to the drawings and initially to FIGS. 1-3, an engine of a radio control model comprises a body (10) including a chamber (11) defined therein. A piston (12) is movably received in the chamber (11). A crank (13) includes a first end pivotally connected to a lower portion of the piston (12) and a second end having a shaft (131) laterally extending from the crank (13). A T-shaped drive axle (14) rotatably extends through the body (10). The T-shaped drive axle (14) has a drive plate (141) radially extending from a first end thereof for driving the shaft (131) and a polygonal head (142) formed on a second end of the T-shaped drive axle (14) for connected to the engine starter of the present invention.

The engine starter in accordance with the present invention comprises an output shaft (20) concentrically connected to the second end of the T-shaped drive axle (14). The output shaft (20) has a socket (21) with a polygonal hole (not shown) for complementally receiving the polygonal head (142) of the T-shaped drive axle (14) and a rod (22) centrally and longitudinally extending from a bottom of the socket (21). The rod (22) has a diameter smaller than that of the socket (21) such that a shoulder (23) is formed on the bottom of the socket (21). The rod (22) has a non-round cross section. A threaded portion (221) is formed on an outer periphery of the rod (22).

A drive wheel (30) is connected with the output shaft (20). The drive wheel (30) has a through hole (31) centrally defined therein to allow the rod (22) pivotally extending through the drive wheel (30). A notch (32) centrally defined in one side of the drive wheel (30) opposite tot the shoulder (23) of the output shaft (20). The drive wheel (30) has a series of straight teeth (33) formed on an periphery thereof and a series of bevel teeth (34) formed on the side opposite to the shoulder (23) and surrounding the notch (32).

A limit wheel (40) is sleeved on the rod (22) of the output shaft (20). The limit wheel (40) has [symbol] -shaped protrusion (42) extending therefrom and received in the notch (32) of the drive wheel (30). A hole (41) is centrally defined in the limit wheel (40) for allowing the rod (22) extending the limit wheel (40). The hole (42) has a cross-section corresponding to that of the rod (22) such that the output shaft (20) is rotated with the limit wheel (40).

A torsion adjust device (50) is mounted to a free end of the rod (22). The torsion adjust device (50) includes a resilient member (52) sleeved on the rod (22) and a nut (51) mounted to the free end of the rod (22). In the preferred embodiment of the present invention, the resilient member (52) is a spring. The nut (51) has a threaded hole (513) centrally defined therein to allow nut (51) screwed onto the threaded portion (221) of the rod (22). The nut (51) has a neck (511) longitudinally extending therefrom and inserted into the resilient member (52), and a flange (512) radially extending therefrom to prevent the resilient member (52) from detaching from the rod (22). The torsion adjust device (50) controls the connecting intensity between the drive wheel (30) and the limit wheel (40) due to the restitution force from the resilient member (52).

A gear box (60) is secured on the body (10) of the engine and corresponds to the T-shaped drive shaft (14). The gear box (60) has a first housing (61) and a second housing (610) abutting each other to defined a chamber (not numbered) for receiving the output shaft (20), the drive wheel (30) and the limit wheel (40) and . A bevel gear (62) is received in the gear box (60) and engaged to the series of the bevel teeth (34) of the drive wheel (30). The bevel gear (62) has first input axle (63) centrally and longitudinally extending therefrom. The first input axle (63) extends through the gear box (60) and a first socket (631) is longitudinally mounted to a free end of the first input axle (63). The first socket (631) is provided for connected to an extra power for driving the bevel gear (62) to drive the drive wheel (30). A straight gear (62) is received in the gear box (60) and engaged to the series of the straight teeth (33) of the drive wheel (30). The bevel gear (64) has second input axle (65) centrally and longitudinally extending therefrom. The second input axle (65) extends through the gear box (60) and a second socket (651) is longitudinally mounted to a free end of the second input axle (65). The second socket (651) is provided for connected to an extra power for driving the straight gear (64) to drive the drive wheel (30).

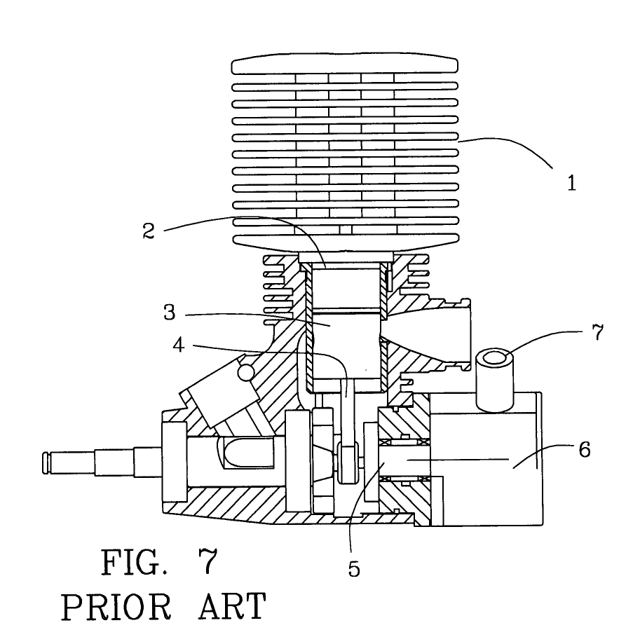

With reference to FIGS. 1 and 6-7, the drive wheel (30), the limit wheel (40) and the torsion adjust device (30) are sequentially connected to the output shaft (20) that is concentrically connected to the T-shaped drive axle (14) and the gear box (60) is mounted on the body (10) of the engine of the radio control model. Consequently, the engine starter of the present invention is easily assembled.

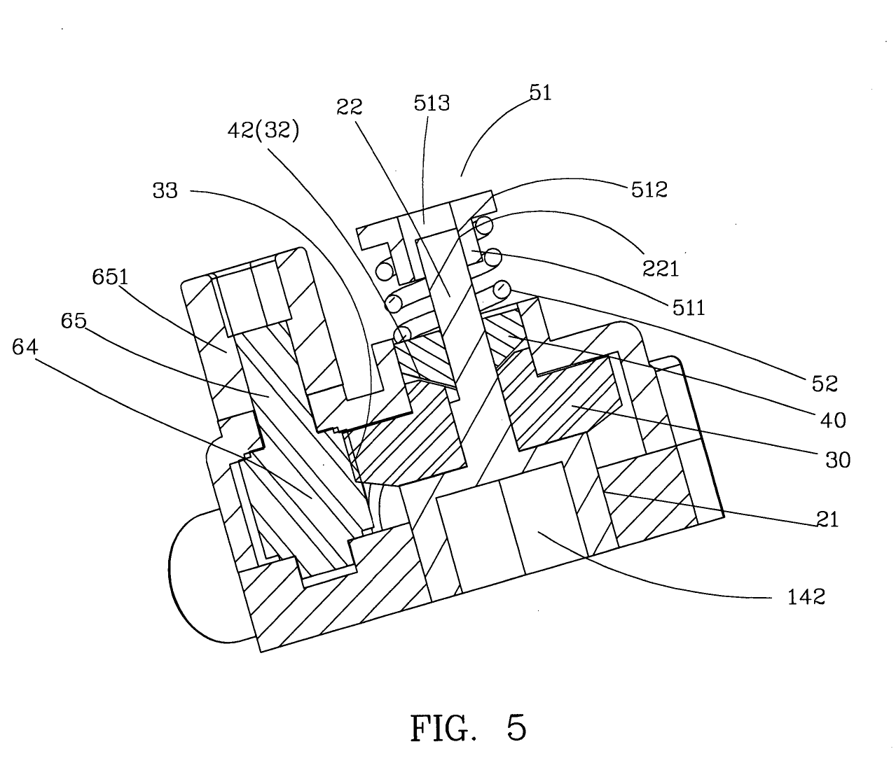

With reference to FIGS. 1 and 5, the straight gear (64) drives the drive wheel (30) due to the extra power. The drive wheel (30) sequentially drive limit wheel (40) and the output shaft (20) to start the engine because the torsion adjust device (50) pushes the limit wheel (40) to make the [symbol] -shaped protrusion (42) engaged the notch (32).

With reference to FIG. 5, the notch (32) of the drive wheel (30) will laterally push the limit wheel (40) to prevent the limit from driving the output shaft (20) when the engine may be locked when the fuel overly enter the carburetor due to a careless operation because the torsion force from the locked engine is much greater than that from the torsion adjust device (50). Consequently, the engine of the radio control model is protected from a forced operation and damage.

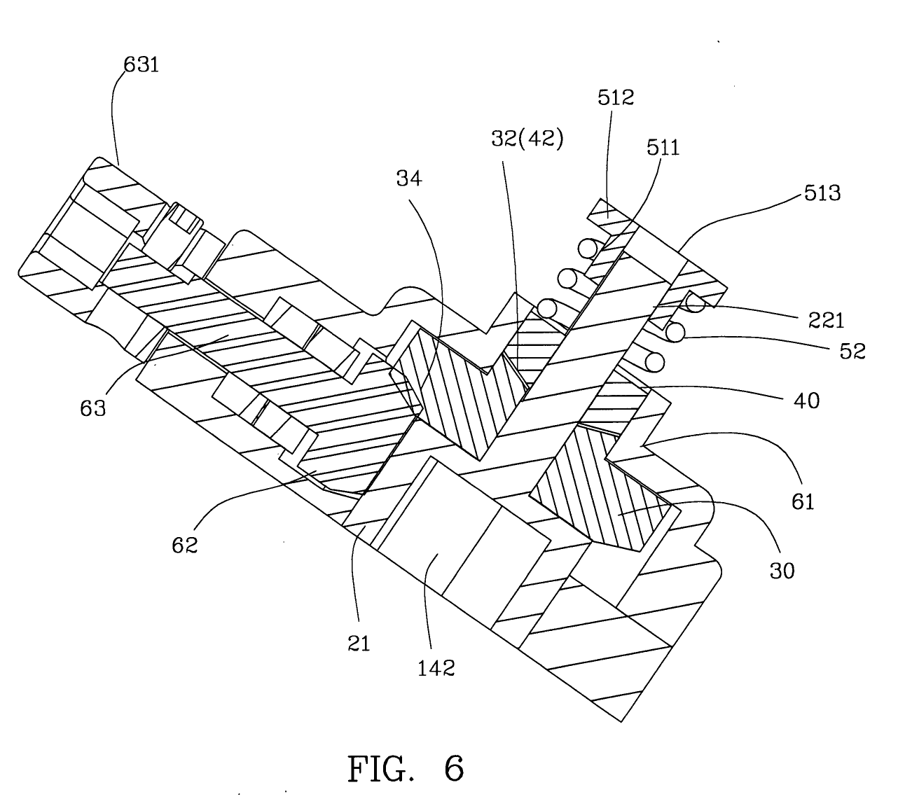

With reference to FIGS. 1 and 6, the bevel gear (62) drives the drive wheel (30) due to the extra power. The drive wheel (30) sequentially drive limit wheel (40) and the output shaft (20) to start the engine because the torsion adjust device (50) pushes the limit wheel (40) to make the [symbol] -shaped protrusion (42) engaged the notch (32).

With reference to FIG. 6, the notch (32) of the drive wheel (30) will laterally push the limit wheel (40) to prevent the limit from driving the output shaft (20) when the engine may be locked when the fuel overly enter the carburetor due to a careless operation because the torsion force from the locked engine is much greater than that from the torsion adjust device (50). Consequently, the engine of the radio control model is protected from a forced operation and damage.

Although the invention has been explained in relation to its preferred embodiment, it is to be understood that many other possible modifications and variations can be made without departing from the spirit and scope of the invention as hereinafter claimed.

What is claimed is:

1. An engine starter for a radio control model comprising:
a output shaft adapted to be concentrically connected to T-shaped drive axle such T-shaped drive axle is rotated to start the engine when the output shaft is rotated;
a drive wheel sleeved on the output shaft for receiving an extra power;
a limit wheel sleeved on the output and synchronously rotated with the output shaft, the limit wheel being selectively driven by the drive wheel;
a gear box adapted to be secured on the engine and provided to receive the output shaft, the drive wheel and the limit wheel; and
a torsion adjust device mounted to a free end of the output shaft after the output shaft extending through the gear box;
whereby the drive wheel is idle running when the torsion force from the engine is greater than that from the torsion adjust device for protecting the engine from a forced operation.

2. The engine starter as claimed in claim 1, wherein the output shaft having a socket for complementally and partially receiving the T-shaped drive axle and a rod centrally and longitudinally extending from a bottom of the socket, a threaded portion formed on an outer periphery of the rod, the torsion adjust device having a resilient member sleeved on the rod and a nut screwed onto the threaded portion of the rod for adjust the torsion from the torsion adjust device.

3. The engine starter as claimed in claim 1, wherein the drive wheel has a series of bevel teeth formed on a one side thereof opposite to the engine.

4. The engine starter as claimed in claim 3, wherein the gear box comprises a bevel gear received therein and engaged to the series of the bevel teeth of the drive wheel, the bevel gear having a first input axle centrally and longitudinally extending therefrom, the first input axle extending through the gear box and a first socket longitudinally mounted to a free end of the first input axle, the first socket provided for connected to an extra power for driving the bevel gear to drive the drive wheel.

5. The engine starter as claimed in claim 1, wherein the drive wheel has a series of straight teeth formed on a periphery thereof.

6. The engine starter as claimed in claim 5, wherein the gear box comprises a straight gear received therein the gear and engaged to the series of the straight teeth of the drive wheel, the bevel gear having second input axle centrally and longitudinally extending therefrom, the second input axle extending through the gear box and a second socket longitudinally mounted to a free end of the second input axle, the second socket provided for connected to an extra power for driving the straight gear to drive the drive wheel.

7. The engine starter as claimed in claim 2, wherein the rod has a non-round cross-section and the drive wheel has a through hole centrally defined therein for allowing the rod extending through the drive wheel, the through hole having a shape corresponding to that of the coos-section of the rod.

8. The engine starter as claimed in claim 2, wherein the nut has a threaded hole centrally defined therein to allow nut screwed onto the threaded portion of the rod, the nut having a neck longitudinally extending therefrom and inserted into the resilient member and a flange radially extending therefrom to prevent the resilient member from detaching from the rod.
